(19) United States
(12) Patent Application Publication
(10) Pub. No.: US 2023/0251933 A1
(43) Pub. Date: Aug. 10, 2023

(54) PREDICTING RECOVERY POINT OBJECTIVE DRIFTS

(71) Applicant: Kyndryl, Inc., New York, NY (US)

(72) Inventors: Divgian SIDHU, Mohali (IN); Ravi Kumar RAGHUNATHAN, Bangalore (IN); Goldy Mathew ALOYSIOUS, Bangalore (IN); Archana DIXIT, AGRA (IN)

(21) Appl. No.: 17/592,852

(22) Filed: Feb. 4, 2022

(51) Int. Cl. G06F 11/14; G06K 9/62; G06F 11/07

(52) U.S. Cl. CPC G06F 11/1451; G06F 11/1471; G06K 9/6256; G06F 11/0781

(57) ABSTRACT

A computer-implemented method includes: generating, by a computing device, a multidimensional hyperspace encompassing a plurality of features based on input data; generating, by the computing device, a plurality of sequential arrays of a fixed length based on the input data; generating, by the computing device, a final sequential array of a predetermined shape based on the plurality of sequential arrays of the fixed length; generating, by the computing device, a training data set for a deep learning model based on the final sequential array of the predetermined shape and the multidimensional hyperspace; and training, by the computing device, a deep learning model using the generated training data set.

### BACKGROUND

Aspects of the present invention relate generally to predicting recovery point objective (RPO) drifts and, more particularly, to predicting RPO drifts with causal factors and generalize on multiple domains.

Disaster recoverability (DR) is a set of policies, tools, and procedures to enable recovery or continuation of technology infrastructure and systems following a natural or human-induced disaster. DR focuses on the technology infrastructure keeping all essential aspects of a business functioning despite significant disruptive events.

### SUMMARY

In a first aspect of the invention, there is a computer-implemented method including: generating, by a computing device, a multidimensional hyperspace encompassing a plurality of features based on input data; generating, by the computing device, a plurality of sequential arrays of a fixed length based on the input data; generating, by the computing device, a final sequential array of a predetermined shape based on the plurality of sequential arrays of the fixed length; generating, by the computing device, a training data set for a deep learning model based on the final sequential array of the predetermined shape and the multidimensional hyperspace; and training, by the computing device, a deep learning model based on the generated training data set.

In another aspect of the invention, there is a computer program product including one or more computer readable storage media having program instructions collectively stored on the one or more computer readable storage media. The program instructions are executable to: generate a multidimensional hyperspace encompassing a plurality of features based on input data; generate a plurality of sequential arrays of a fixed length based on the input data; generate a final sequential array of a predetermined shape based on the plurality of sequential arrays of the fixed length; generate a training data set for a deep learning model based on the final sequential array of the predetermined shape and the multidimensional hyperspace; and train the deep learning model based on the generated training data set.

In another aspect of the invention, there is system including a processor, a computer readable memory, one or more computer readable storage media, and program instructions collectively stored on the one or more computer readable storage media. The program instructions are executable to: generate a multidimensional hyperspace encompassing a plurality of features based on input data; generate a plurality of sequential arrays of a fixed length based on the input data; generate a final sequential array of a predetermined shape based on the plurality of sequential arrays of the fixed length; generate a training data set for a deep learning model based on the final sequential array of the predetermined shape and the multidimensional hyperspace; and train the deep learning model based on the generated training data set.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a diagram of an analytics device according to an embodiment of the present invention.

FIG. 6 shows a deep learning model architecture according to an embodiment of the present invention.

FIG. 7 shows a flowchart of an exemplary method in accordance with aspects of the invention.

FIGS. 8 and 9 show examples of tables according to embodiments of the present invention.

### DETAILED DESCRIPTION

Aspects of the present invention relate generally to predicting recovery point objective (RPO) drifts and, more particularly, to predicting RPO drifts with causal factors and generalize on multiple domains. Disaster recoverability (DR) operations do not get early warnings for workload/application RPO related issues, resulting in clients not being able to meet business service level agreements (SLAs), incurring penalties and decline in client satisfaction. Further, DR operations hamper repeat business with a client. Also, analyzing RPO deviations takes anywhere from a couple of hours to a couple of days, which results in downtime and a severe loss for the business. In addition, in many cases, the reasons for the RPO deviations may not be known and the process of finding the reasons and rectifying the RPO deviations is a time-consuming and highly manual task. Under existing approaches, current RPO values (also called recovery point actual (RPA) values) are calculated in real-time, but no information is available about future values. In particular, although deviation patterns are available, root causes are unknown. Therefore, when a break-down occurs, finding root causes is performed manually, which takes time and is a huge loss in today's always on and on demand era. Also, customers are oblivious as to what operations frequently affect the RPO deviations.

Aspects of the invention address the above mentioned problems by predicting RPO/RPA drifts for a definite future time window with a constant time interval using deep learning. Further, the aspects of the invention include a configurable time window and a time interval. In embodiments, each future prediction at a constant time interval is assigned a corresponding confidence score which is utilized to prioritize necessary actions to be performed on these drifts. In embodiments, the top influencing factors for these RPO/RPA drifts are extracted using interpretable artificial intelligence (AI) and probabilistic behavior (e.g., high, medium, or low) is computed using historical data points from the last n hour windows (i.e., n can be any integer value greater than zero). Further, the n hour windows are configurable (i.e., n can be any integer value greater than zero). In embodiments, enabling ingestion of a ground truth into a model allows for continual learning and makes the model more robust and reliable as time passes. In embodiments, the system leverages learning from one domain to generate predictions on other domains without any need for model designing and training from scratch.

According to an aspect of the invention, there is a computer-implemented process for disaster recoverability (DR), the computer-implemented method including: predicting recovery point objectives (RPO) drifts for a predetermined time window with a predetermined time interval using deep learning, assigning a confidence score for each prediction at the predetermined time interval, extracting influencing factors for the RPO drifts using artificial intelligence and probabilistic behavior computed using historical data points from a predetermined window, continual real-time learning by enabling ingestion of ground truth into a model, and generating predictions for at least one domain based on historical learning data from another domain.

Implementations of the invention provide an improvement in the technical field of predictive RPA drifts by providing a practical application of proactively achieving service level agreements (SLAs) with improved customer satisfaction and increased market share for a disaster recovery solution. Implementations of the invention provide an improvement in the technical field of disaster recovery by providing a practical application for effective resiliency management . Implementations of the invention provides a differentiated system capability by providing a practical application of an analytics driven resiliency management capability within a hybrid multi-cloud environment. Implementations of the invention provide an improvement in the technical field of an intelligent resiliency management by providing a practical application of accelerating a cognitive enterprise by providing visibility into application uptime, recoverability and effectively increasing application uptime, recoverability and addressing revenue leakage from gaps in DR coverage for a client.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

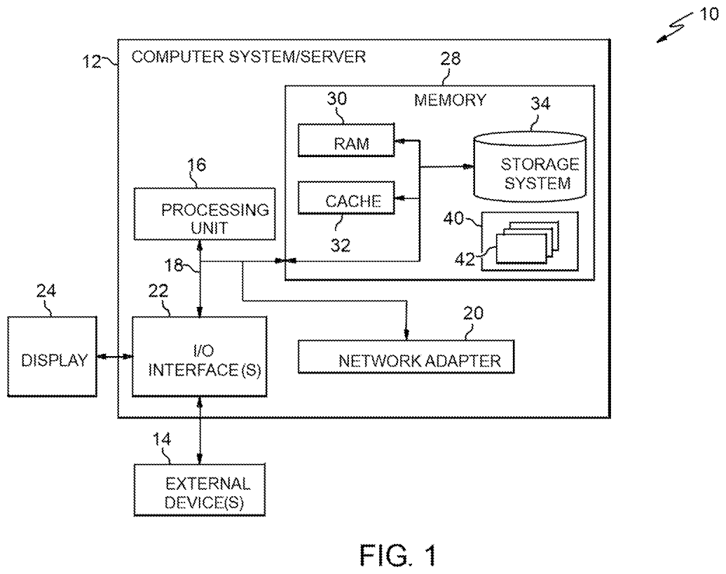

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

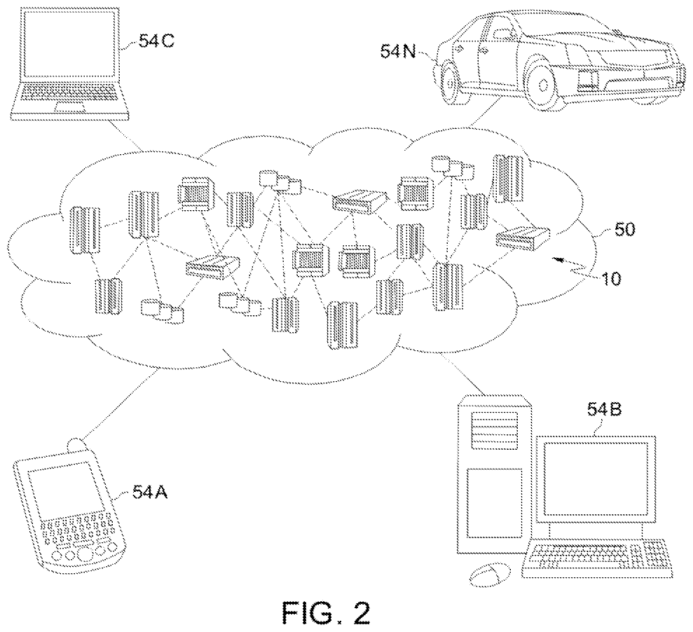

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

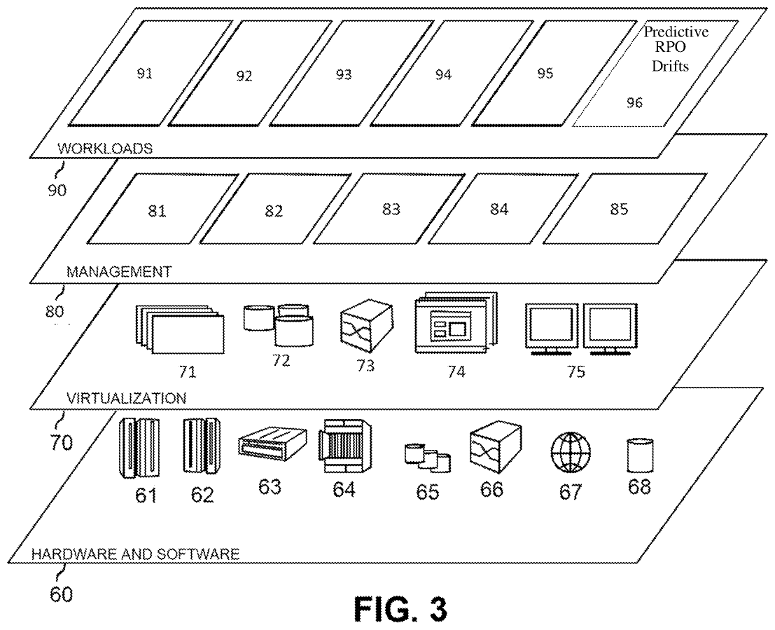

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and predictive RPO drifts 96.

Implementations of the invention may include a computer system/server 12 of FIG. 1 in which one or more of the program modules 42 are configured to perform (or cause the computer system/server 12 to perform) one of more functions of the predictive RPO drifts 96 of FIG. 3. For example, the one or more of the program modules 42 may be configured to: generate a multidimensional hyperspace encompassing a plurality of features based on input data; generate a plurality of sequential arrays of a predetermined shape based on the plurality of sequential arrays of the fixed length; and generate a training data set for a deep learning model based on the final sequential array of the predetermined shape and the multidimensional hyperspace.

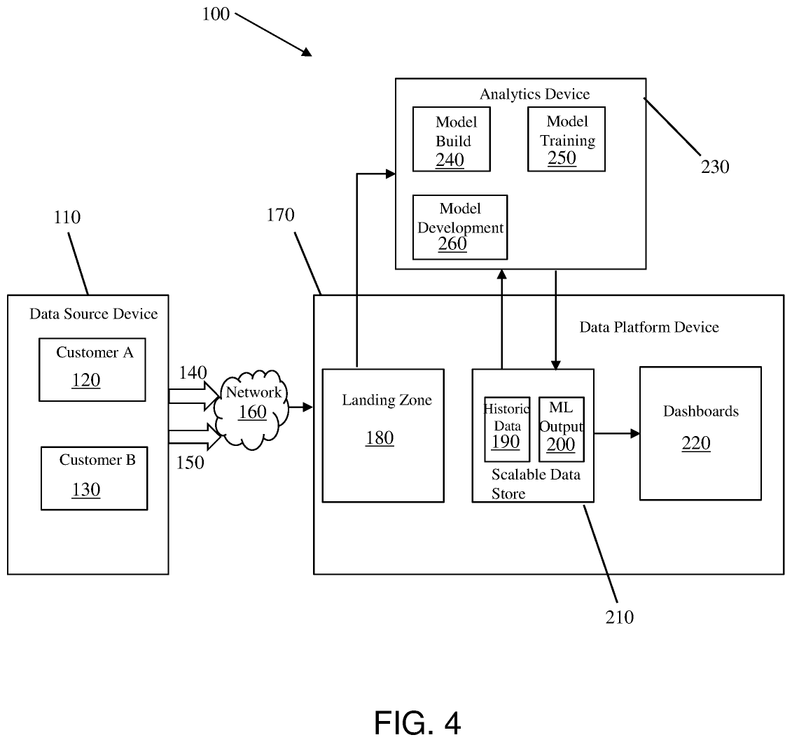

FIG. 4 shows a block diagram of an exemplary environment in accordance with aspects of the invention. In embodiments, the environment includes a network 160 providing communication between data source device 110 and a data platform device 170 through an application programming interface (API) 140 and streamed data 150. Further, the data source device 110 communicates with an analytics device 230 through the data platform device 170. The network 160 may be any one or more communication networks such as a LAN, WAN, and the Internet, and communications thereof.

In embodiments, the data source device 110 comprises a computing device including one or more elements of the computer system/server 12 of FIG. 1. In another example, the data source device 110 comprises a virtual machine (VM). In embodiments, and in both examples, the data source device 110 comprises a customer A 120 and a customer B 130. Each of the customer A 120 and the customer B 130 may comprise one or more program modules such as program modules 42 described with respect to FIG. 1. Further, the customer A 120 and the customer B 130 may include logs, metrics, and RPO metrics. The data source device 110 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the data platform device 170 comprises a computing device including one or more elements of the computer system/server 12 of FIG. 1. In another example, the data platform device 170 comprises a virtual machine (VM). In embodiments, and in both examples, the data platform device 170 comprises a landing zone 180, a scalable data store 210, and dashboards 220. In further embodiments, the scalable data store 210 comprises historic data 190 and a machine learning (ML) output 200. The landing zone 180 and the scalable data store 210 may be deployed on one or more servers. Each of the landing zone 180, the scalable data store 210, and the dashboards 220 may comprise one or more program modules such as program modules 42 described with respect to FIG. 1. The data platform device 170 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the analytics device 230 comprises a computing device including one or more elements of the computer system/server 12 of FIG. 1. In another example, the analytics device 230 comprises a virtual machine (VM). In embodiments, and in both examples, the analytics device 230 comprises model build 240, model training 250, and model development 260. Each of the model build 240, the model training 250, and the model development 260 may comprise one or more program modules such as program modules 42 described with respect to FIG. 1. The analytics device 230 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In a cloud implementation, the network 160 comprises or is part of the cloud environment 50 of FIG. 2, the data source device 110 comprises one or more cloud computing nodes 10 of FIG. 2, and the data platform device 170 and the analytics device 230 comprise one of the local computing devices 54A-N of FIG. 2.

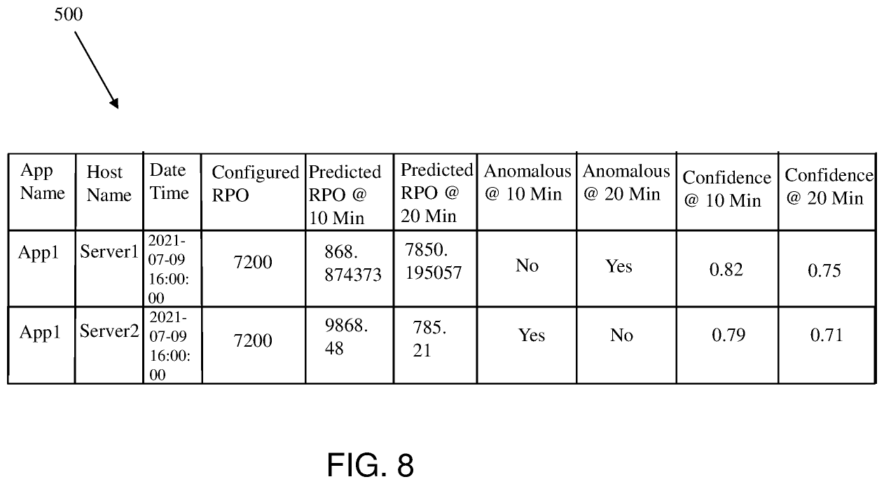

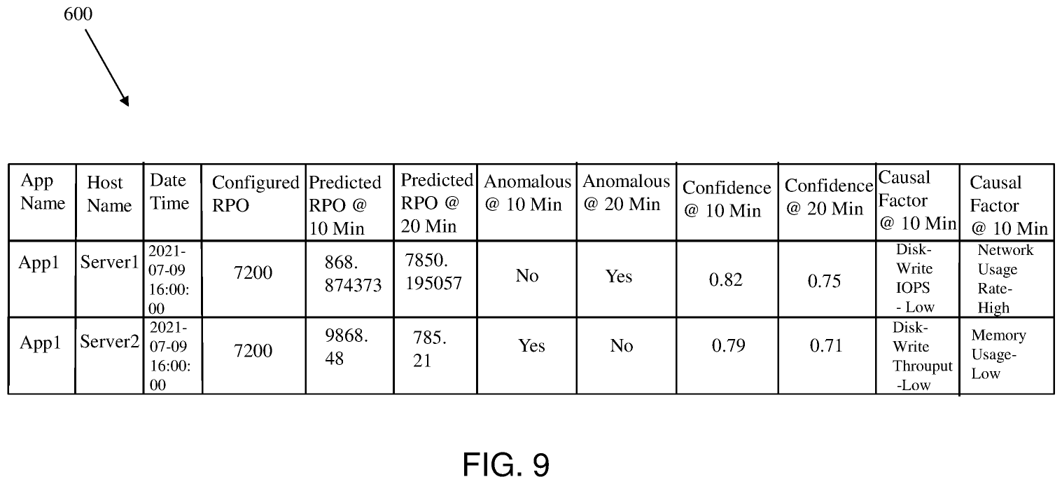

With continued reference to FIG. 4, in embodiments, each of the customer A 120 and the customer B 130 of the data source device 110 may include the logs, the metrics, and the RPO metrics which are sent to the data platform device 170 through the application programming interface (API) 140 and the streamed data 150 via the network 160. In embodiments, the landing zone 180 of the data platform device 170 receives the logs, the metrics, and the RPO metrics via the network 160. Further, the landing zone 180 sends the logs, the metrics, and the RPO metrics to the analytics device 230. The analytics device 230 sends the machine learning (ML) output data to the ML output 200 for storage in the scalable data store 210. Further, the logs, the metrics, and the RPO metrics in the analytics device 230 are sent to the scalable search store 210. The scalable data store 210 also can send the logs, the metrics, and the RPO metrics back to the analytics device 230 for processing. The scalable data store 210 sends the ML output data from the ML output 200 to the dashboards 220 for visualization. The visualization of the dashboards 220 can include tables (e.g., FIGS. 8 and 9) of root causes and graphs of monitored metrics for customers to access and review (e.g., customers of the customer A 120 and the customer B 130 or other customers).

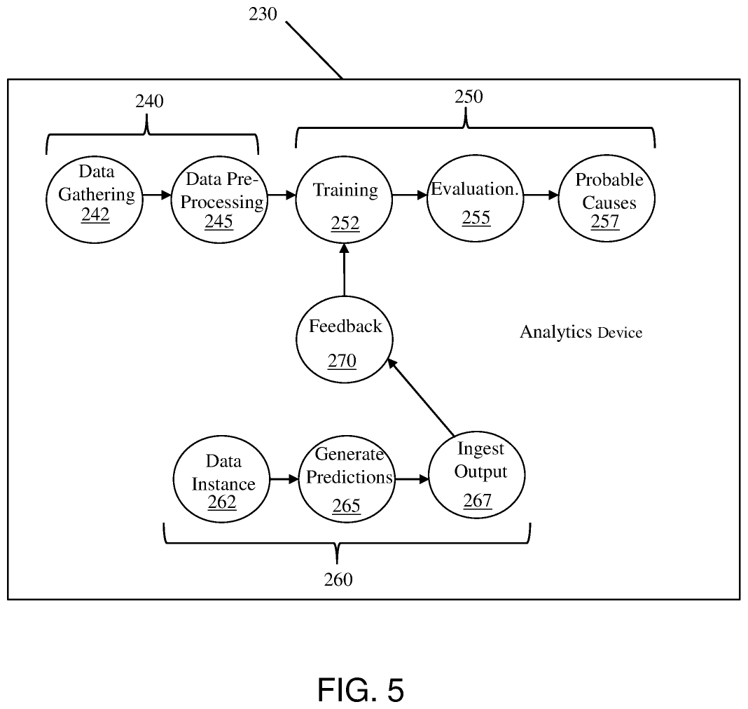

In an embodiment, as a result of the embodiments described in FIG. 4, a multidimensional hyperspace is built using input data (e.g., logs, metrics, and RPO metrics from the customer A 120 and the customer B 130) from the business criticality data across applications, the real time data in system configuration changes for a data center (DC) and disaster recoverability (DR), the systems management data including metrics, the events, the performance, the logs, the software currency data, the network (e.g., wide area network (WAN)), the service management data including change management, the patches, the inventory data, the discovery data, and the historical/time series for RPO and considers these features for n timestamps in the past to generate predictions. In an embodiment, the multidimensional hyperspace comprises a structured data set which is multidimensional (i.e., across each dimension of the business criticality data across applications, the real time data in system configuration changes for a data center (DC) and disaster recoverability (DR), the systems management data including metrics, the events, the performance, the logs, the software currency data, the network (e.g., wide area network (WAN)), the service management data including change management, the patches, the inventory data, the discovery data, and the historical/time series for RPO) and includes a plurality of features (system configuration changes, systems and application monitoring and network metrics, events, performance, logs, and historical series for a recovery point objective (RPO)). Choosing the “n” timestamp window is configurable. In embodiments, and as described with respect to FIGS. 4 and 5, the multidimensional hyperspace is generated by the model build 240 of the analytics device 230. For example, the multidimensional hyperspace includes historical data points from a predetermined time period. In this example, the historical data points of the multidimensional hyperspace include a plurality of features such as whether memory usage is high or low, whether disk write throughput is high or low, and whether network usage rate is high or low.

FIG. 5 shows a flowchart of a method performed by an analytics device 230 (of FIG. 4) according to an embodiment of the present invention. Steps of the method may be carried out in the environment of FIG. 4 and are described with references to the elements depicted in FIG. 4. In FIGS. 4 and 5, in embodiments, the model build 240 of the analytics device 230 gathers the input data (i.e., logs, the metrics, and the RPO metrics) in the data gathering step 242 from the data platform device 170 and pre-processes the logs, the metrics, and the RPO metrics in the data pre-processing step 245. For example, at the data gathering step 242, the model build 240 of the analytics device 230 receives the input data (i.e., logs, the metrics, and the RPO metrics) from the landing zone 180 of the data platform 170. In particular, the landing zone 180 of the data platform 170 receives the input data (i.e., logs, the metrics, and the RPO metrics) from the data source device 110 (i.e., the customer A 120 and the customer B 130) and sends the input data (i.e., logs, the metrics, and the RPO metrics) to the model build 240. In another example, at the data pre-processing step 245, the model build 240 of the analytics device 230 pre-processes the logs, the metrics, and the RPO metrics by generating sequential arrays of a fixed length and generating a final sequential array of a predetermined shape for performing training on the processed logs, metrics, and RPO metrics. The sequential arrays include system configuration changes, system and application monitoring and network metrics, events, performance, logs, and historical series for a recovery point objective (RPO) of a fixed length (i.e., predetermined time interval). Further, the model build 240 generates the final sequential array of the predetermined shape based on the sequential arrays of the fixed length by combining the sequential arrays into the final sequential array with a predetermined shape. The predetermined shape corresponds to a shape of a final sequential array, i.e., an array length of the final sequential array, a number of observations of the final sequential array, and the number of features of the final sequential array. In this example, at the data pre-processing step 245, the model build 240 of the analytics device 230 generates a training data set which is ready for a deep learning model based on the final sequential array of the predetermined shape and the multidimensional hyperspace. In particular, the training data set includes system configuration changes, system and application monitoring and network metrics, events, performance, logs, and historical series for a recovery point objective (RPO) of a predetermined time interval from the final sequential array of the predetermined shape across each dimension of the business criticality data across applications, the real time data in system configuration changes for a data center (DC) and RPA, the systems management data including metrics, the events, the performance, the logs, the software currency data, the network (e.g., wide area network (WAN)), the service management data including change management, the patches, the inventory data, the discovery data, and the historical/time series for RPO from the multidimensional hyperspace. Therefore, the training data set provides system and performance data over a predetermined time interval across many dimensions which is useful in iteratively training the deep learning model.

The model development 260 also receives the input data (i.e., logs, the metrics, and the RPO metrics) in the data instance step 262, generates predictions based on the logs, the metrics, and the RPO metrics in the generate predictions step 265, and ingests the output (i.e., predictions) to the scalable data store 210 in the ingest output step 267. In an example, at the generate predictions step 265, the model development 260 generates the predictions using the input data (i.e., logs, the metrics, and the RPO metrics) across multiple areas, such as business criticality data across applications, real time data in system configuration changes for a data center (DC) and RPA, systems management data including metrics, events, performance, logs, software currency data, network (i.e., wide area network), service management data including change management, patches, inventory and discovery data and historical time/series data for RPO. In embodiments, in the generate predictions step 265, the generated predictions can be based on a previously trained model from the model training 250. The output (i.e., predictions) is then sent back to the model training 250 in the feedback step 270.

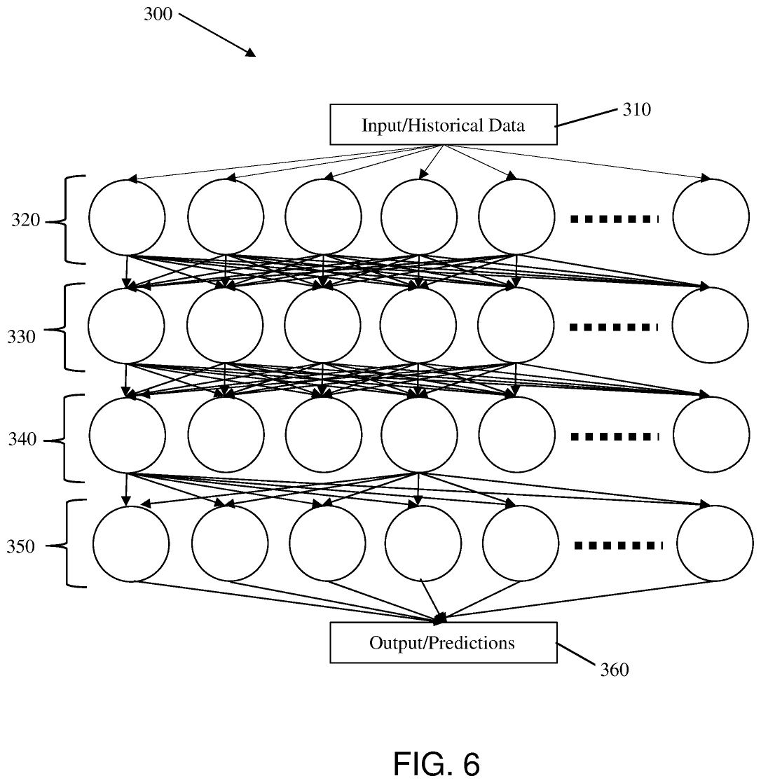

In the training step 252, the model training 250 receives the pre-processed logs, metrics, and RPO metrics from the model build 240 and the ingested output (i.e., predictions) from the model development 260 via the feedback step 270, and then performs training on the received data (i.e., the pre-processed logs, metrics, and RPO metrics and the ingested output). In an example, at the training step 252, the model training 250 trains a deep learning model using the received data ((i.e., the pre-processed logs, metrics, and RPO metrics and the ingested output)) and at least one bidirectional long short-term memory layer (LSTM) described in FIG. 6. In another example, at the training step 252, the model training 250 trains the deep learning model using the final sequential array of the predetermined shape and the multidimensional hyperspace and at least one bidirectional long short-term memory layer (LSTM) described in FIG. 6. Then, the model training 250 evaluates the trained data in the evaluation step 255 and generates the probable causes in the probable causes step 257. In an example, at the evaluation step 255, the model training 250 evaluates the trained data using historical data of the input data and assigns a confidence score. The model training 250 then sends the generated probable causes to the dashboards 220 for customer visualization of tables and graphs related to the generated probable causes.

FIG. 6 shows a deep learning model architecture according to an embodiment of the present invention. In an embodiment, the deep learning model architecture 300 is included in the model training 250 of the analytics device 230. In the deep learning model architecture 300, the input/historical data 310 is received at an input layer 320. The input/historical data 310 in the input layer 320 is separated into combined weights of different parameters to get an expected output and to minimize/lessen the error function and then sent to a first bidirectional long short-term memory (LSTM) layer 330. The first bidirectional long short-term memory (LSTM) layer 330 allows for both backward and forward information in a sequence at every time interval. Thus, the first bidirectional LSTM layer 330 preserves information from both the past and the future. Then, the output data from the first bidirectional LSTM layer 330 is passed to a second bidirectional LSTM layer 340 and the process is repeated again for the second bidirectional LSTM layer 340. The output data from the second bidirectional LSTM layer 340 is then sent to a dense layer 350. The dense layer 350 then uses the output data from the second bidirectional LSTM layer 340 to generate output/predictions 360. The generated output/predictions 360 can then be sent to the dashboards 220 for customer visualization of tables and graphs related to the generated output/predictions 360.

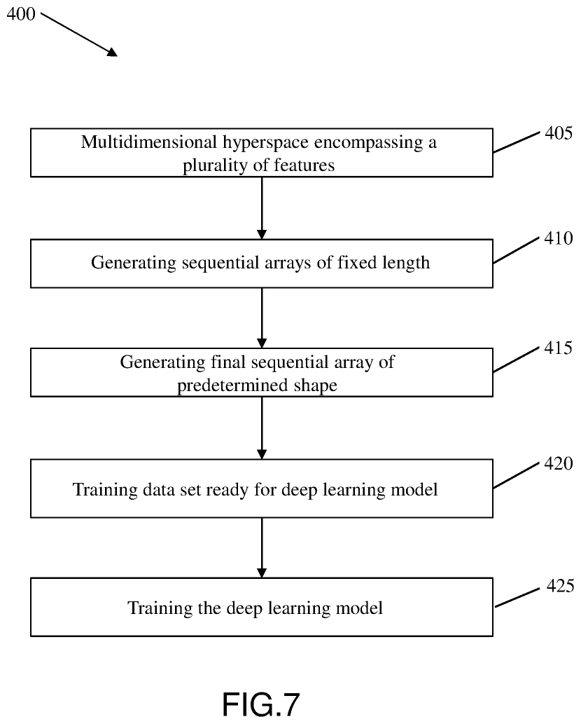

FIG. 7 shows a flowchart of an exemplary method in accordance with aspects of the present invention. Steps of the method may be carried out in the environment of FIGS. 4 and 5 and are described with reference to elements depicted in FIGS. 4 and 5. In the flowchart 400, at step 405, the system generates a multidimensional hyperspace encompassing a plurality of features from data in the data platform device 170. In embodiments, and as described with respect to FIGS. 4 and 5, the multidimensional hyperspace is generated by the model build 240 of the analytics device 230. In particular, the plurality of features includes system configuration changes, system and application monitoring and network metrics, events, performance, logs, and historical/time series for RPO.

At step 410, the system generates a plurality of sequential arrays of a fixed length from data in the data platform device 170. In embodiments, and as described with respect to FIGS. 4 and 5, the plurality of sequential arrays of the fixed length are generated by the model build 240 of the analytics device 230. In embodiments, the sequential arrays include system configuration changes, system and application monitoring and network metrics, events, performance, logs, and historical series for a recovery point objective (RPO) of a fixed length (i.e., predetermined time interval). In particular, the fixed length (i.e., predetermined time interval) of the sequential arrays is a configurable parameter. In an embodiment, the fixed length may be 24 timestamps in the past which accounts for four hours at an interval of 10 minutes.

At step 415, the system generates a final sequential array of the predetermined shape from the plurality of sequential arrays of the fixed length. In embodiments, and as described with respect to FIGS. 4 and 5, the final sequential array is generated by the model build 240 of the analytics device 230. In one example, the model build 240 generates the final sequential array of the predetermined shape based on the sequential arrays of the fixed length by combining the sequential arrays into the final sequential array with a predetermined shape. In particular, the predetermined shape includes a number of observations, an array length, and a number of features. The predetermined shape corresponds to a shape of a final sequential array, i.e., an array length of the final sequential array, a number of observations of the final sequential array, and the number of features of the final sequential array.

At step 420, the system generates a training data set which is ready for a deep learning model based on the final sequential array of the predetermined shape and the multidimensional hyperspace. In embodiments, the training data set includes system configuration changes, system and application monitoring and network metrics, events, performance, logs, and historical series for a recovery point objective (RPO) of a predetermined time interval from the final sequential array of the predetermined shape across each dimension of the business criticality data across applications, the real time data in system configuration changes for a data center (DC) and RPA, the systems management data including metrics, the events, the performance, the logs, the software currency data, the network (e.g., wide area network (WAN)), the service management data including change management, the patches, the inventory data, the discovery data, and the historical/time series for RPO from the multidimensional hyperspace. Therefore, the training data set provides system and performance data over a predetermined time interval across many dimensions which is useful in iteratively training the deep learning model. In embodiments, and as described with respect to FIGS. 4 and 5, the training data set is generated by the model build 240 of the analytics device 230. Further, in embodiments, the training data set is sent to the model training 250 of the analytics device 230 for generating and/or training a deep learning model.

At step 425, the system trains the deep learning model based on the generated training data set. In embodiments, and as described with respect to FIGS. 4-6, the deep learning model is trained by the model training 250. In one example, the model training 250 trains the deep learning model using the final sequential array of the predetermined shape and the multidimensional hyperspace and at least one bidirectional long short-term memory layer (LSTM) described in FIG. 6.

In aspects of the present invention, an embodiment includes a method to predict RPO drifts for a predetermined time window (e.g., one hour) in future with a constant time interval (e.g., 10 minutes) using deep learning. In embodiments, and as described with respect to FIGS. 4 and 5, the method to predict RPO using deep learning is generated by the model training 250 of the analytics device 230. In the method to predict RPO drifts, the constant time interval and the predetermined time window are configurable. Further, in embodiments, customers are notified and warned about future RPO drifts in advance so that preventative measure/actions are taken to mitigate the downtime for critical business applications. The embodiments also entail combining and preprocessing data from multiple areas such as business criticality data across applications, real time data in system configuration changes for a data center (DC) and RPA, systems management data including metrics, events, performance, logs, software currency data, network (e.g., wide area network (WAN)), service management data including change management, patches, inventory data, discovery data, and historical/time series for RPO. In embodiments, and as described with respect to FIGS. 4 and 5, the combining and preprocessing of the data is generated by the model build 240 of the analytics device 230.

FIG. 8 shows an example of a table according to embodiments of the present invention. In embodiments, each future prediction at the constant time interval is assigned a corresponding confidence score. In embodiments, and as described with respect to FIGS. 4 and 5, the assigning of the correspondence confidence score is generated by the model training 250 of the analytics device 230. The corresponding confidence score is utilized to prioritize the actions on these drifts. These predictions are also flagged with whether they are anomalous or not. Since deep learning models do not provide any confidence score out of the box, the method leverages sampling of “thinned” networks which results by application of dropout. Sampling is carried out for enough times to generate a distribution to calculate the confidence score of the original model's predictions. The confidence score helps in determining the uncertainty of the model. In particular, the further in the future the predictions are generated, the lower the confidence score. The table 500 in FIG. 8 includes the application name, the host name, the date and time, the configured RPO, the predicted RPO@10 minutes, the predicted RPO@20 minutes, anomalous@10 minutes, anomalous@20 minutes, confidence@10 minutes, and confidence@20 minutes. The table 500 illustrates two futuristic predictions at an interval of 10 minutes. In another embodiment, at least six predictions may be generated at an interval of 10 minutes (i.e., for a one hour future).

FIG. 9 shows an example of a table according to embodiments of the present invention. In embodiments, the method provides the customers with top factors influencing these RPO drifts. In embodiments, and as described with respect to FIGS. 4 and 5, the method providing top and probable factors influencing these RPO drifts is generated by the model training 250 of the analytics device 230. The method entails extracting the most probable factors contributing to these drifts using explainable/interpretable artificial intelligence (AI). Further, the method also computes probable behavior for these influencing factors. For example, the influencing factors include whether memory or disk write is high or low. These factors are computed using historical data points from the last n hours window. The “n” hours window is configurable (e.g., 4 hours window). The table 600 in FIG. 9 includes the application name, the host name, the date and time, the configured RPO, the predicted RPO@10 minutes, the predicted RPO@minutes, anomalous@10 minutes, anomalous@20 minutes, confidence@10 minutes, confidence@20 minutes, causalfactors@10 minutes, and causalfactors@20 minutes.

In aspects of the present invention, an embodiment includes a method which enables ingestion of a ground truth into a model for continual learning. In embodiments, and as described with respect to FIGS. 4 and 5, the method which enables ingestion of the ground truth into the model is generated by the model development 260 of the analytics device 230. This makes the model more robust and reliable at time passes each day and enhances model prediction capabilities. Real values are captured as and when drift events occur, and this data is fed into the model training pipeline so that the model can learn from current events and improve over a period of time. RPO drifts account for a tiny fraction of overall volume. Therefore, this approach also uses resampling techniques to ensure a model is able to learn all possible patterns from a large number of drift scenarios.

In aspects of the present invention, an embodiment includes a method which is used to predict current RPO for a variety of other domains once learning (i.e., model training) is performed on one domain. In embodiments, and as described with respect to FIGS. 4 and 5, the method which is used to predict current RPO for a variety of other domains once learning (i.e., model training) is performed on one domain is generated by the model training 250 of the analytics device 230. Even though these drifts are triggered due to a business process, not all hardware, software, and network systems have similar configurations. Therefore, leanings from one domain are employed to generate predictions on other domains. Moreover, data persistency is often a challenge and collecting data is a time-consuming activity. Therefore, this system would immensely help if a deep learning model trained on one client data is leveraged and fine-tuned to generate predictions for other client data. Deep learning models are notorious for being data hungry and resource intensive, leveraging data from across domains is an efficient way to “Learn once and predict in multiple domains”. This would also reduce the need to design and train the model from scratch, resulting in significant savings in time and resource compute.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a computing device, a multidimensional hyperspace encompassing a plurality of features based on input data;
generating, by the computing device, a plurality of sequential arrays of a fixed length based on the input data;
generating, by the computing device, a final sequential array of a predetermined shape based on the plurality of sequential arrays of the fixed length;
generating, by the computing device, a training data set for a deep learning model based on the final sequential array of the predetermined shape and the multidimensional hyperspace; and
training, by the computing device, the deep learning model based on the generated training data set.

2. The method of claim 1, wherein the plurality of features comprises system configuration changes, system and application monitoring and network metrics, events, performance, logs, and historical series for a recovery point objective (RPO).

3. The method of claim 1, wherein the fixed length of the sequential arrays comprises a predetermined number of timestamps within a time interval.

4. The method of claim 3, wherein the fixed length is a configurable parameter.

5. The method of claim 1, wherein the predetermined shape includes a number of observations, an array length, and a number of features.

6. The method of claim 1, wherein the training the deep learning model based on the training data set further comprises training the deep learning model based on the training data set using at least one bidirectional long short-term memory (LSTM) layer.

7. The method of claim 6, wherein the at least one bidirectional LSTM layer preserves information from both the past and the future of the input data.

8. The method of claim 6, wherein the deep learning model generates predictions for recovery point objective (RPO) drifts in a domain based on the at least one bidirectional LSTM layer.

9. The method of claim 8, wherein the deep learning model sends the predictions to dashboards for customer visualization.

10. The method of claim 8, further comprising generating a confidence score for each of the predictions based on a distribution of the predictions from the deep learning model.

11. The method of claim 8, further comprising predicting another recovery point objective (RPO) for another domain based on the predictions in the domain.

12. The method of claim 1, wherein the computing device includes software provided as a service in a cloud environment.

13. A computer program product comprising one or more computer readable storage media having program instructions collectively stored on the one or more computer readable storage media, the program instructions executable to:
generate a multidimensional hyperspace encompassing a plurality of features based on input data;
generate a plurality of sequential arrays of a fixed length based on the input data;
generate a final sequential array of a predetermined shape based on the plurality of sequential arrays of the fixed length;
generate a training data set for a deep learning model based on the final sequential array of the predetermined shape and the multidimensional hyperspace; and
train the deep learning model based on the generated training data set.

14. The computer program product of claim 13, wherein the program instructions are further executable to train the deep learning model based on the training data set using at least one bidirectional long short-term memory (LSTM) layer.

15. The computer program product of claim 14, wherein the program instructions are executable to generate predictions for recovery point objective (RPO) drifts in a domain based on the at least one bidirectional LSTM layer.

16. The computer program product of claim 15, wherein the program instructions are executable to generate a confidence score for each of the predictions based on a distribution of the predictions from the deep learning model.

17. A system comprising:
a processor, a computer readable memory, one or more computer readable storage media, and program instructions collectively stored on the one or more computer readable storage media, the program instructions executable to:
generate a multidimensional hyperspace encompassing a plurality of features based on input data;
generate a plurality of sequential arrays of a fixed length based on the input data;
generate a final sequential array of a predetermined shape based on the plurality of sequential arrays of the fixed length;
generate a training data set for a deep learning model based on the final sequential array of the predetermined shape and the multidimensional hyperspace; and
train the deep learning model based on the generated training data set.

18. The system of claim 17, wherein the program instructions are further executable to train the deep learning model based on the training data set using at least one bidirectional long short-term memory (LSTM) layer.

19. The system of claim 18, wherein the program instructions are executable to generate predictions for recovery point objective (RPO) drifts in a domain based on the at least one bidirectional LSTM layer.

20. The system of claim 19, wherein the program instructions are executable to generate a confidence score for each of the predictions based on a distribution of the predictions from the deep learning model.
